(19) United States
(12) Patent Application Publication
(10) Pub. No.: US 2016/0294568 A1
(43) Pub. Date: Oct. 6, 2016

(54) PACKET ENERGY TRANSFER POWERED TELECOMMUNICATIONS SYSTEM FOR DISTRIBUTED ANTENNA SYSTEMS AND INTEGRATED WIRELESS FIDELITY SYSTEM

(71) Applicant: John Mezzalingua Associates, LLC, Liverpool, NY (US)

(72) Inventors: Shawn M. Chawgo, Cicero, NY (US); Todd Landry, Grayslake, IL (US)

(73) Assignee: John Mezzalingua Associates, LLC, Liverpool, NY (US)

(21) Appl. No.: 15/086,674

(22) Filed: Mar. 31, 2016

Related U.S. Application Data
(60) Provisional application No. 62/142,520, filed on Apr. 3, 2015.

(51) Int. Cl. H04L 12/10; H02J 1/00

(52) U.S. Cl. CPC H04L 12/10; H02J 1/00

(57) ABSTRACT

A telecommunication system including a master unit operative to receive/transmit data from at least one base transceiver station, at least one telecommunication antenna operative to receive/transmit the data wirelessly to and from wireless communication devices, a remote unit connecting the master unit to the telecommunications antenna and including a ground-hardened outer casing and a digital or packet energy transfer (PET) power distribution system is integrated with the operative to transfer packets of digital energy from a transmitter to a PET receiver, the PET receiver powering the remote unit and disposed internally of the ground-hardened outer casing thereof.

### CROSS-REFERENCE TO RELATED APPLICATIONS

This application is a non-provisional patent application of, and claims the benefit and priority of, U.S. Provisional Patent Application No. 62/142,520 filed on Apr. 3, 2015. The entire contents of such applications are hereby incorporated by reference.

### BACKGROUND

Telecommunication systems employ a variety of cellular systems and devices to wirelessly transmit/receive voice and data signals over large geographic, or small confined, areas. Outdoor macro telecommunications sites typically employ, inter alia, a plurality of telecommunications antennas, e.g., sector antennas, mounted atop elevated towers/scaffolding/buildings, for the purpose of transmitting/receiving RF signals, i.e., providing cellular coverage, over a large geographic area. Such land-based antennas may communicate with orbital telecommunications satellites, localized telecommunications systems or Distributed Antenna Systems (DAS).

Distributed Antenna Systems (DAS) augment radio frequency (RF) communications, i.e., cellular coverage, provided by global satellite or land-based antenna systems. More specifically, a DAS provides coverage in spaces, buildings, tunnels, etc., which would otherwise block, attenuate, absorb or interfere with the RF signals/energy transmitted/received by the global satellite systems. Such spaces include high-rise buildings, hotels, stadiums, universities, casinos, etc., where RF coverage is essential for uninterrupted and reliable telecom service. The objective of a Distributed Antenna System (DAS) is to provide a uniform RF coverage within a confined space to optimally or selectively distribute RF energy within the space.

Land-based antennas or Macro Antenna Systems (MAS) typically include: (i) a Base Transceiver Station (BTS) providing RF signals from local service providers, e.g., Verizon, Comcast, AT&T etc., through a Base-Band Unit (BBU), (ii) a Remote Radio Unit (RRU) communicating RF data with the BBU and operative to augment, amplify, attenuate, and transmit RF signals received from the BBU, (iii) a plurality of telecommunication antennas each connecting to an RRU, and a (iv) a tower/scaffolding/elevating structure for mounting the RRU and telecommunication antennas. The BBU is disposed in the equipment room/Base Transceiver Station (BTS) and connected to the RRU via a combination of optical fiber and copper wire.

Similarly, a Distributed Antenna Systems, or DAS typically includes, at one end: (i) a plurality of Base Transfer/Transceiver Stations (BTS) providing the RF signals of each service provider, e.g., Verizon, Comcast, AT&T etc., (ii) a DAS head-end for receiving, handling, and manipulating the various RF signals of the Base Transfer/Transceiver Stations, (iii) a plurality of Remote Units (RUs) amplifying/attenuating signals received from the DAS head-end, and (iv) a telecommunications antenna connecting to each of the remote units at the other end of the DAS. Similar to a MAS, the DAS head-end connects to each of the RUs by a plurality of conductive and fiber optic cables.

A DAS may comprise a variety of system types including passive, active and hybrid systems. Passive systems employ conventional coaxial cables to distribute telecommunication signals within an internal space, active systems typically employ optic fiber cable to distribute RF signals, while hybrid systems employ a combination of the passive and active systems. A passive system is less complex to implement inasmuch as coaxial cable is inherently capable of handling multiple carrier frequencies employed by the RF service providers. However, the strength of the radio signal rapidly diminishes the more distal the cable is from the signal source. Consequently, passive systems are not well-suited for large facilities having long/complicated cable runs, and cannot provide end-to-end cable monitoring. Active DAS, on the other hand, delivers strong and consistent signals at every node irrespective the distance from the signal source. Furthermore, active DAS is capable of monitoring nearly all system components, e.g. the remote units and antennas, using conventional Simple Network Management Protocol (SNMP). Additionally, an perhaps most importantly, fiber optic cable, used in active DAS, can be run over large distances without losing signal strength. Moreover, fiber optic cable can be less expensive to install inasmuch as the cabling is lighter and easier to deploy across ceilings and in tight spaces.

One difficulty or challenge common to both MAS and DAS telecommunication systems relates to providing economical and safe power to each system. More particularly, one challenge relates to minimizing the cost of providing copper cable over large distances. Generally, copper wire having a diameter corresponding to a gauge of between about two (2) to four (4) will be required to transmit high voltage across a relatively short distance, e.g., a run of above fifty to one-hundred feet (50 ft-100 ft.), which corresponds approximately to the height of a conventional cell-tower/elevated structure. Inasmuch as the diameter of the copper wire cable is approximately two to two and one-half inches (2″-2½″), such copper wire cable cannot be easily wound around a spool for distribution/storage/transport and must be specially-ordered wherever such cable is needed for fabrication, maintenance or repair of a cell-tower. Additionally, it will be appreciated that the lead-time for fabrication can be several weeks to several months.

Additionally, the copper wire cable used to carry such voltages must remain “Class 2” compliant for the purpose of fire and electric shock safety. To be Class 2 compliant, the telecommunications system must be powered by an analog circuit having a potential less than (<) about 60 volts with a total power less than (<) about 1000 watts. Alternatively, the wire cable must be protected within a conduit and installed by a licensed electrician. As a consequence, the cost to install a DAS in a typical stadium or high-rise building can be prohibitive, e.g., in excess of $670,000, when considering the cost of employing a licensed electrician, at some $67.00/ft to install. With respect to a MAS, the cell tower and cable may be inherently protected within a fenced or secure perimeter. However, this protection does not reduce the cost of the heavy gauge copper wire used to transmit power and data from the base transfer station to a remote radio unit mounted atop a typical cell tower.

The foregoing background describes some, but not necessarily all, of the problems, disadvantages and challenges related to the reuse of cable connectors.

### BRIEF DESCRIPTION OF THE DRAWINGS

Additional features and advantages of the present disclosure are described in, and will be apparent from, the following Brief Description of the Drawings and Detailed Description.

FIG. 1 is a schematic diagram illustrating an example of one embodiment of an outdoor wireless communication network.

FIG. 2 is a schematic diagram illustrating an example of one embodiment of an indoor wireless communication network.

FIG. 3 is a schematic view of a telecommunication system including a Distributed Antenna System DAS integrated with, and powered by, a Packet or Digital Energy Transfer power distribution system.

FIG. 4 depicts a plurality of telecommunication antennas disposed in a substantially open square space or area and radiating unidirectional RF energy in substantially all directions.

FIG. 5 depicts a plurality of telecommunication antennas disposed in a substantially elongate rectangular space or corridor and radiating directional RF energy along the length of the corridor.

FIG. 6 depicts an array of directional telecommunications antennas disposed within a substantially elongate rectangular-shaped space.

FIG. 7 is a schematic view of the PET power distribution system for use in combination with the DAS of the present disclosure.

FIG. 8 is a schematic view of another embodiment of the telecommunication system including a WIFI internet/WAP system integrated with the PET powered distribution system.

### SUMMARY OF THE INVENTION

A telecommunication system is also described including: (i) a master unit operative to exchange data from at least one base transceiver station, (ii) at least one telecommunication antenna operative to exchange the data with the wireless communication devices, (iii) a remote unit connecting the master unit to the telecommunications antenna and including a ground-hardened outer casing, and, (iv) a digital or Packet Energy Transfer (PET) power distribution system operative to transfer packets of electrical energy from a transmitter to a PET receiver, the PET receiver powering the remote unit and disposed internally of the ground-hardened outer casing thereof.

A power-data distribution system is provided including a digital or packet energy transfer (PET) system, a converter, a conductive cable and a fiber optic cable. The PET system transmits discrete packets of digital energy and produces a continuous stream of analog power. The converter reduces the analog power from a first to a second potential which is lower than a threshold potential. A conductive cable transmits the discrete packets of digital energy from a power source to a load while a fiber optic cable exchanges data between a data source and the target device.

### DETAILED DESCRIPTION

### Overview

The following describes various components of a Wireless Telecommunication System. In one embodiment, a local telecommunication system is described in the context of a Distributed Antenna System or DAS which includes a plurality of small canister antennas distributed within a defined space. In other embodiments, a regional or global telecommunication system is described in the context of a Macro Antenna System or MAS which includes a tower/elevated structure to mount an antenna system which sends and receives data by an orbiting satellite and/or land-based antenna systems.

In one or more subsequent sections, each of the DAS and MAS telecommunication systems are powered by an integrated Packet Energy Transfer (PET) System. In one embodiment, a wireless fidelity (WIFI) system is integrated with the PET-powered telecommunication system for communicating with Wireless Application Protocol/Access Point (WAP) enabled devices.

In each embodiment, the DAS/MAS telecommunication systems include a Network Switching Subsystem (“NSS”) having a circuit-switched core for making phone connections. The NSS also includes a general packet radio service architecture which enables mobile networks, such as 2G, 3G and 4G mobile networks, to transmit Internet Protocol (“IP”) packets to external networks such as the Internet.

A service provider or carrier operates a plurality of centralized mobile telephone switching offices (“MTSOs”) each controlling a base transceiver station associated with a MAS within a select/cellular region surrounding the MTSO. One or more DAS may operate within, and transfer telecommunications signals between, telecommunication system subscribers and the head-end of a service provider. The DAS may also distribute WIFI for connection to a Wireless Access Port or WAP of an Internet connection.

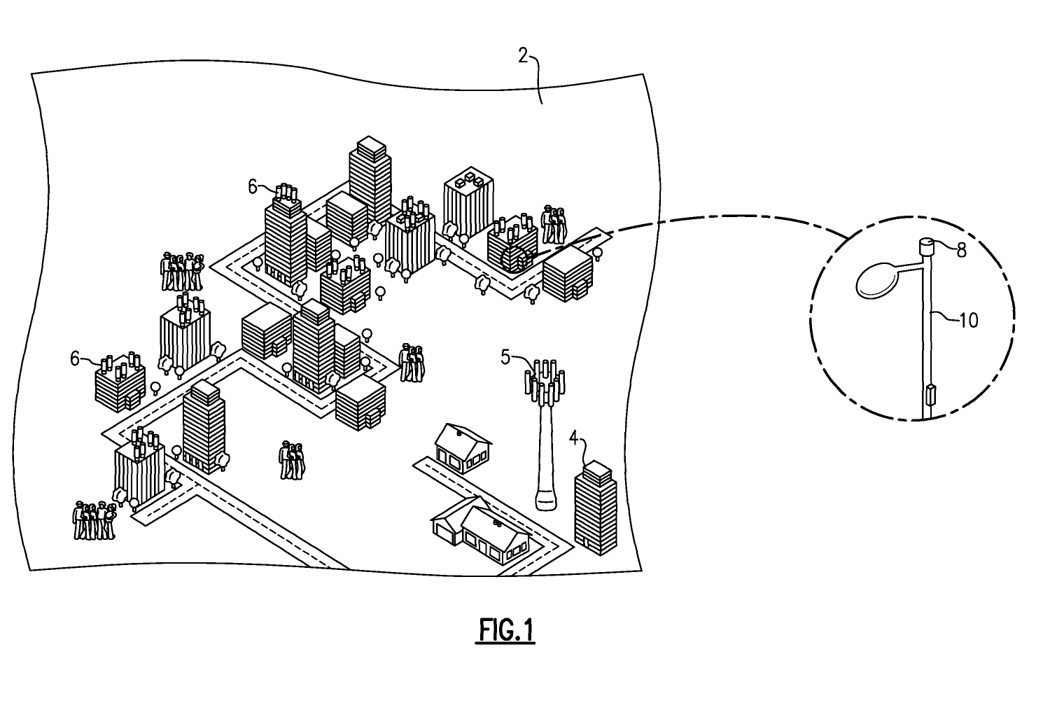

In FIG. 1, a Macro Antenna System or MAS 2 includes a cell site or a cellular base transceiver station 4. The base transceiver station 4, in conjunction with the cellular tower 5, services communication devices such as mobile phones in a defined area surrounding the base transceiver station 4. The MAS antennas 8 are disposed on the cellular tower 5 or may be mounted to buildings or other elevated structures such as, for example, street lamps.

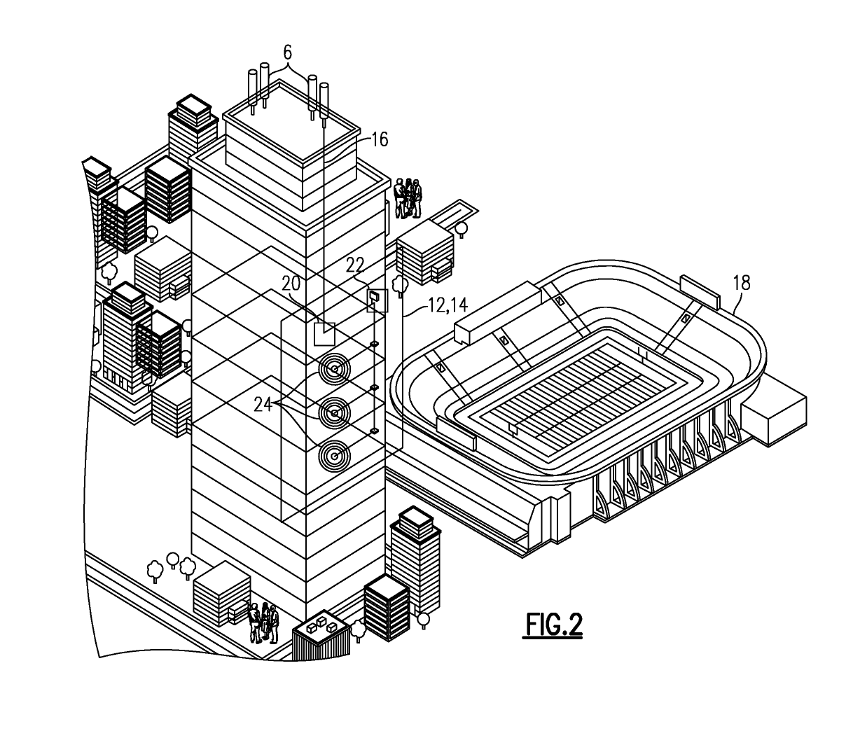

In FIG. 2, a Distributed Antenna System 10 includes a plurality of canister antennas 6 electrically coupled to a remote unit or Radio Frequency (“RF”) repeater 20 (hereinafter RF repeater). The DAS 10 can, for example, be installed in a variety of buildings and/or enclosures which have structures or materials which interfere with the RF signal which would otherwise be obtained directly from a satellite or a land-based MAS 2. For example, a DAS 10 may be installed in a high-rise office building 16a, a sports stadium 16b, a shopping mall 16c or other similar enclosures 16. Inasmuch as it can be sometimes difficult to provide RF coverage to internal spaces within such enclosures 16, the DAS 10 provides a link for all telecommunications subscribers within the enclosure 16. An RF repeater 20 amplifies and repeats the received signals, i.e., from the nearby MAS 2. The RF repeater 20 is coupled to a DAS head end or head-end unit 22 which, in turn, is coupled to a plurality of remote antenna units 24 distributed throughout the building 16. Depending upon the embodiment, the DAS head end 22 can manage over one hundred remote antenna units 24 within a building.

Packet Energy Transfer (PET)

While the foregoing provided a brief overview of a MAS and DAS telecommunication systems 2, 10, the following discussion describes a novel power source therefor. More specifically, each of the MAS/DAS telecommunication systems 2, 10 includes a power source which employs Digital Energy or Packet Energy Transfer (PET) technology. Before discussing the PET-Powered telecommunication systems 2, 10, it will be useful to briefly describe this type of power source/supply.

Digital Energy or Packet Energy Transfer (PET) technology (hereinafter referred to as Packet Energy or “PET”) is a power distribution system which separates electrical power into a series of discrete time domains referred to as digital energy packets. Each packet includes a first time domain for energy transfer, and a second time domain for digital/analog signature verification. Using this approach, much higher levels of power can be safely transmitted from a power source to a load, i.e., downstream equipment. For example, three-hundred and forty-five volts (DC 345 V) can be safely delivered using PET technology in contrast to just fifty-six volts (DC 56 V) when delivering analog power over a conventional Category 5 or Category 6 cable. More specifically, PET technology is capable of distinguishing between an individual/technician inadvertently making contact with a power conductor and the current drawn by powered equipment

Specifically, a sensing circuit is provided to rapidly determine when a hazardous/potentially dangerous condition is present. The circuit shut downs down before another packet of high voltage digital energy is transferred. The same circuit safely, and continuously, operates when detecting that the potential draw is steady, such as when electrically powered equipment draws current from the power source. This sensing circuit has proven to be sufficiently reliable that regulatory authorities now consider digital energy/PET technology to be on a par with an analog Ground Fault Interrupt (GFI) circuit—deemed, by some, to be the gold-standard in safety in analog circuitry.

A Packet Energy Transfer (PET) system suitable for powering the telecommunications systems described herein is more fully described in Eaves U.S. Pat. No. 8,068,937 entitled “Power Distribution System with Fault Protection Using Energy Packet Confirmation,” filed Feb. 4, 2009, and Eaves U.S. Pat. No. 8,781,637 entitled “Safe Exposed Conductor Power Distribution System,” filed Dec. 7, 2012 which are both incorporated herein by reference in their entirety.

PET-Powered Telecommunication System (DAS Embodiment)

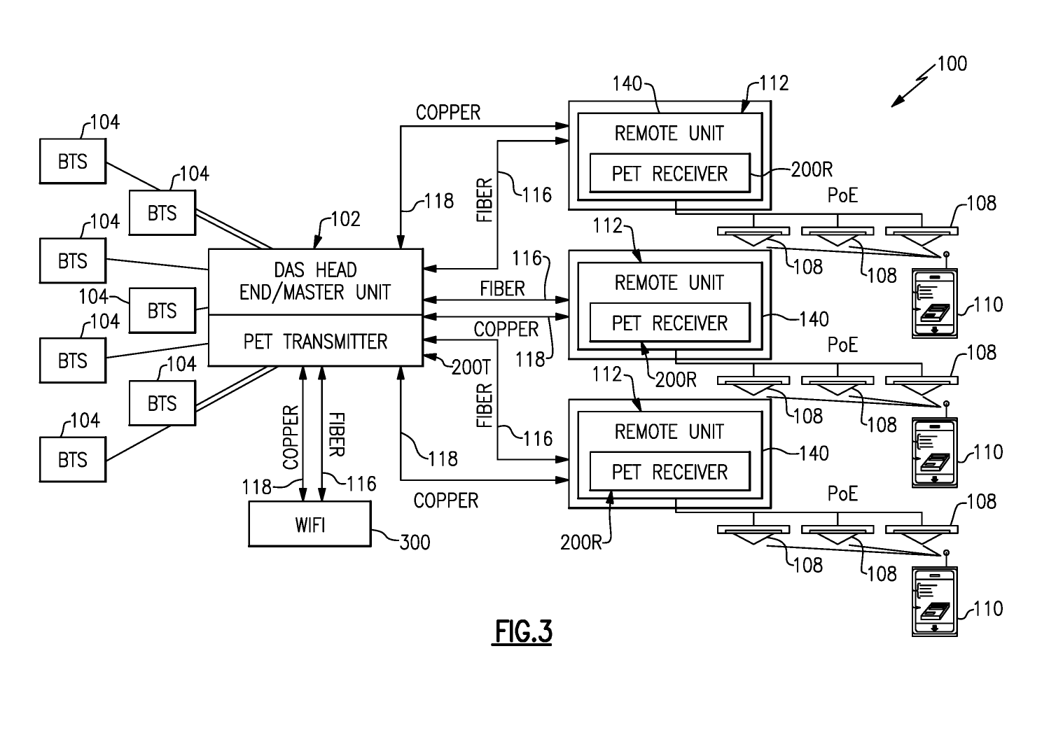

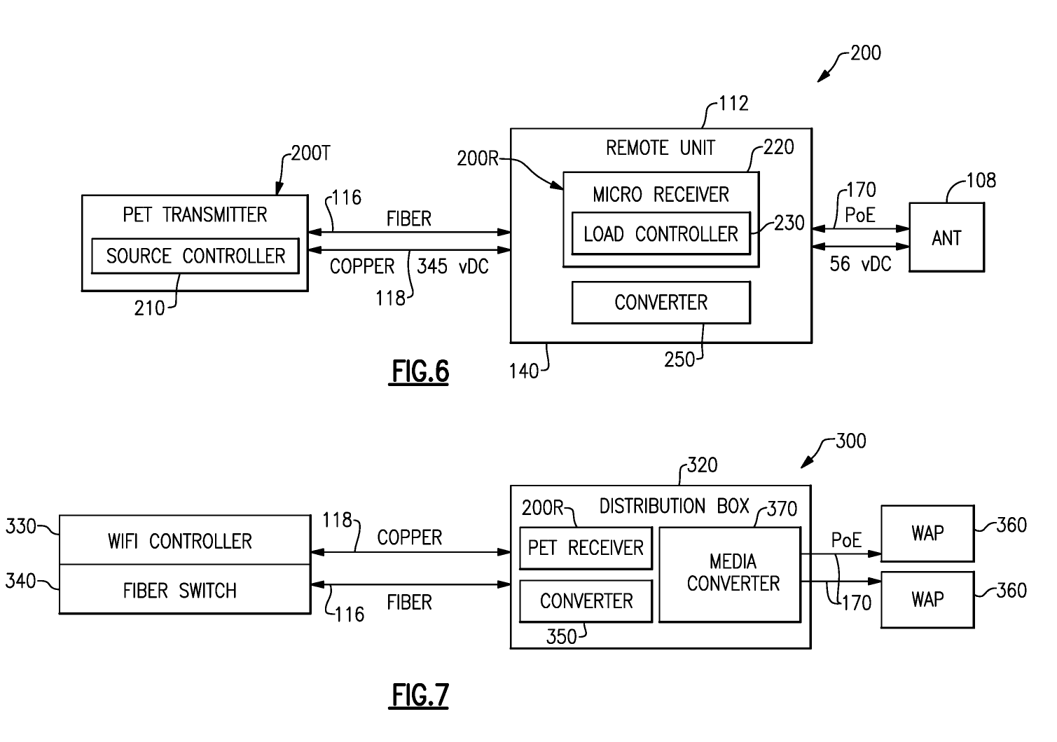

In FIGS. 3 and 6, a PET-powered telecommunication system 100 includes: (i) a master or headend unit 102 connecting to one or more cellular radio/Base Transceiver Stations (BTS) 104, e.g., operated by a service provider such as Verizon, Comcast, AT&T, etc., (ii) one or more telecommunication antennas 108 transmitting/receiving RF signals to/from a plurality of cellular devices 110, e.g., a cellular telephone operated by one of a plurality of telecommunications subscribers, (iii) one or more remote units 112 interposing and connecting the master unit 102 to each of the telecommunication antennas 108, and (iv) a digital or Packet Energy Transfer (PET) system 200 operative to provide electrical power to at least the remote units 112. In the described embodiment, the PET system 200 powers the master unit 102, the cellular radios/BTUs 104, and a Wireless Fidelity (WiFi) System 300 in addition to the remote units 112. As used herein, the term “cellular radio” may be used interchangeably with: (i) a BTS unit, (ii) a Radio Base Station (RBS), (iii) a small cell radio, (iv) a metro radio, (v) a node B, or an (vi) enode B (eNB) unit.

In the described embodiment, the DAS telecommunication system 100 provides an even distribution or blanket of RF energy within a prescribed/selected/confined space. As discussed in a preceding paragraph, such spaces include high-rise buildings, hotels, stadiums, universities, casinos etc., where RF energy from external satellite or Macro Antenna Systems may be blocked from entering the space due to attenuating/absorptive structure employed in its construction. Accordingly, the DAS telecommunication system 100 reduces interference, isolation and reflection losses in the signals exchanged between an internet/network-enabled device and a service provider.

More specifically, the master unit 102 processes the telecommunication signals transmitted/received by the BTS Units 104, i.e., the signals from the various service providers, such that all of the signals and frequencies of the various carriers may be transmitted/received by one of the target devices, i.e., a target device which may exchange data such as a telecommunications antenna 108 or a Wireless Access Point (WAP) 360. The master unit 102 of the DAS telecommunication system 100 communicates with, i.e., sends/receives the RF signals to/from, each of the remote units 112 by an optic fiber cable 116. Inasmuch as the optic fiber cable 116 is highly efficient, such fiber cable is employed to minimize signal losses over large distances, e.g., greater than about eight hundred feet (800′). To further improve efficiency, optic signals may be carried or transmitted by multiplexing the optical signal. Alternatively, Wave Division Multiplexing (WDM) may be employed to improve throughput across the fiber optic cable 116. This feature will be discussed in greater detail hereinafter.

While the fiber optic cable 116 is capable of transmitting RF signals over large distances, i.e., without the need for amplifiers or repeaters, it is not capable of transmitting power. Accordingly, the fiber optic cable 116 is accompanied by a conventional metallic pair of copper wire cables 118 along its length. In view of the magnitude of the voltage transferred by the copper wire cable 118, i.e., three-hundred forty-five volts (DC 325 V), a sixteen (16) to twenty (20) gauge, Category 5/6, wire may be employed to convey power to the remote units 112 and/or to the telecommunication antennas 108. While the described embodiment illustrates a separate cable, i.e., fiber and copper cables 116, 118, for exchanging data and transmitting power, the optic fiber cable 116 and wire cabling 118 may be bundled in a single hybrid cable (not shown), i.e., contained within a common flexible plastic or elastomeric sheath. Furthermore, since the fiber, copper or hybrid cable transmits high voltage PET energy, e.g., DC 325 V, while providing a level of safety commensurate with much lower power systems, e.g., fifty-six volts (DC 56 V), there is no requirement to protect the cables 116, 118 in an electrical conduit. Moreover, the hybrid cable or fiber/copper cables, 116, 118 need not be installed by a licensed electrical tradesman, e.g., an electrician.

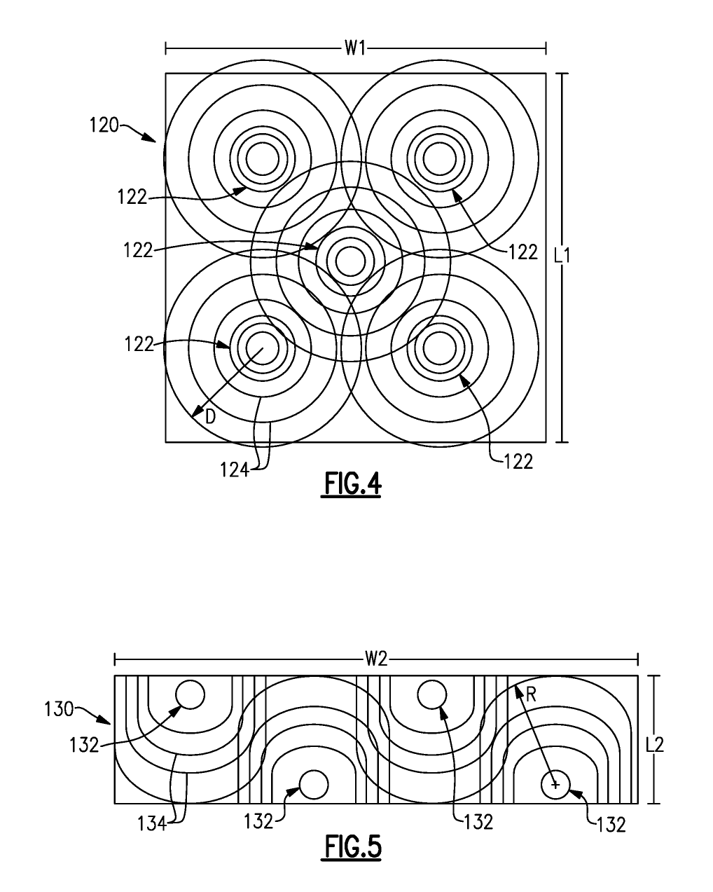

The telecommunications antennas 108 comprise a plurality of micro antennas providing a combination of omnidirectional and directional coverage to blanket a space. Open areas, such as a square space 120 shown in FIG. 4 having substantially equal length and width dimensions, L1 and W1, respectively, may be best serviced by a plurality of unidirectional antennas 122 each having three-hundred and sixty degrees (360°) of coverage, i.e., a circular pattern 124 radiating outwardly to a prescribed diameter D. Elongate areas, e.g., a corridor, such as the rectangular space 130 shown in FIG. 5, having a substantially larger length dimension L2 than width dimension W2, may be best served by staggering inwardly facing directional antennas 132 each having one-hundred eighty degrees (180°) of coverage. These antennas 132 may radiate outwardly, i.e., a prescribed radius R, in a semi-circular pattern.

At least one remote unit 112 connects each of the telecommunication antennas 108 to the Master Unit 102 through the optic and copper cables 116, 118. As discussed above, each remote unit 112 is operative to amplify/attenuate/repeat the RF signals received from the BTS 104 through the Master unit 102 of the DAS telecommunication system 100. Each remote unit 112 includes a ground-hardened, conductive, outer casing 140 for containing and protecting the internal components of the remote unit 112. The remote unit 112 also includes band-specific linear amplifiers and IF filtering to effectively amplify the signals generated by the BTS carriers while blocking bands which fall outside the desired RF coverage.

In FIGS. 3 and 6, the Packet Energy Transfer (PET) system 200 (FIG. 6) includes a PET Transmitter 200T and at least one PET Receiver 200R. In the described embodiment, the PET transmitter 200T produces and transmits packets of digital energy for delivery to a PET receiver 200R disposed within each of the remote units 112. More specifically, packets of digital energy, e.g., three-hundred and forty-five volts (DC 325 V) of power, are provided by the PET transmitter 200T for delivery along the metallic copper wire cable 118. The digital energy packets are delivered at regular intervals/increments by a source controller 210 to the PET receiver 200R. In the described embodiment, the PET Receiver 200R includes at least one PET micro-receiver 220 disposed within a ground-hardened metallic outer casing 140 to enclose each remote unit 112. The micro-receiver 220 receives the digital energy packets from the PET transmitter 200T and includes a load controller 230 having a sensing circuit which detects a threshold difference between: (i) a constant electrical current drawn by the respective remote unit 112, and (ii) an electrical current drawn in response to a short circuit, (DC∞V) or other condition characterized by a difference between a threshold value and a sensed value. A short-circuit may be caused by an individual contacting the conductors of the sensing circuit. Another condition, such as an open circuit, may be present when a sensed value (e.g., DC 0 V) and a threshold value differ by a threshold amount. When this condition is met, the micro-receiver 220 discontinues the regular or periodic transmission of digital energy packets across the power cable 118 from the PET transmitter 200R to the PET receiver 200R.

While remote units of the prior art typically operate at a voltage level below about fifty-six volts (DC 56 V) in order to power a one-thousand Watt (1000 W) unit, the remote units 220 of the present disclosure operate at three-hundred forty-five volts (DC 325 V) to provide an equivalent level of power. Each micro-receiver 200R may include a transformer, or a DC-to-DC converter 250, for reducing the voltage from three-hundred forty-five volts (DC 325 V) to fifty-six volts (DC 56 V) to power each of the telecommunications antennas 108. A Power-over-Ethernet cable 170 may be used to transmit/receive data between the telecommunication antennas 108 and the micro-receiver 200R while using the same cable 170 for powering each of the telecommunications antennas 108.

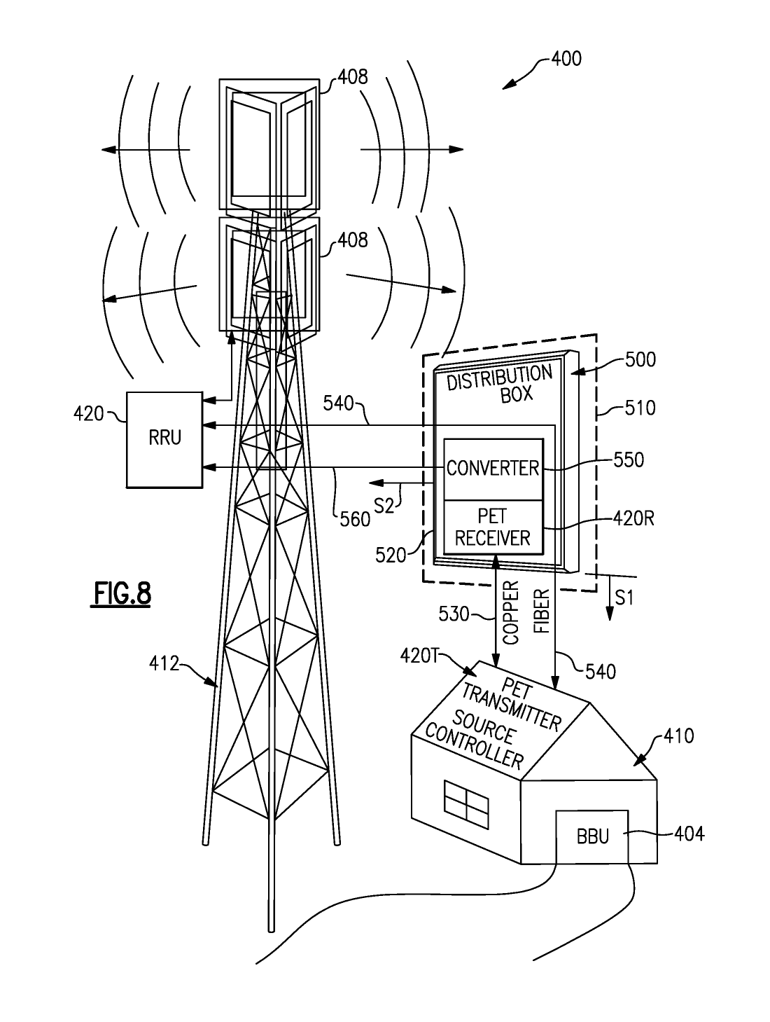

In FIG. 7, a wireless fidelity (WIFI) system 300 may be integrated with the Distributed Antenna Telecommunication System 100 (FIG. 3) and the Packet Energy Transfer (PET) power distribution system 200 (FIG. 6). In this embodiment, a distribution box 320 is interposed between a WIFI controller/switch 330/340, and a plurality of WIFI Access Points (WAPs) 360. The distribution box 320 converts the power received from the PET distribution system 300 into a usable form while powering a Media Converter 370 to convert fiber-optic signals to conventional electronic signals and visa-versa (i.e., between the WAPs 360 and Master Unit 220 of the Distributed Antenna System 200.) More specifically, the distribution box 320 includes: (i) a micro-receiver 200R for receiving the three-hundred forty-five volt DC (DC 345 V) power, i.e., in the form of digital energy packets, from the PET Transmitter 304, (ii) the Media Converter 370, and (iii) a Power Converter 350 (e.g., a DC-to-DC converter) for converting the three-hundred forty-five volts (DC 345 V) power packets to a steady fifty-six volts DC power (DC 56 V) for powering the Media Converter 370.

The Media Converter 370 receives fiber optic signals from a conventional fiber optic cable 116 and converts the signals into conventional electronic signals. These electronic signals may then be conveyed along a wire/copper cable 118 to a target device, e.g., such as a canister antenna. Accordingly, the Media Converter 370 transforms data which can be transmitted over an optic cable 116 into data which can be transmitted over a wire cable.

In this case, the power received by the PET receiver 310 is converted into analog power for use by a Power-over-Ethernet (PoE) cable. r-Ethernet (PoE) cable 170 may be used to transmit/receive data between each of the WAPs 360 and the PET receiver 200R while using the same cable 170 for powering each of the WAPs 360. Accordingly, all of the WAPs 360, which can exceed 100 units in for many DAS systems 200, may be powered by a Power-over-Ethernet (PoE) cable 170 in contrast to running power to each of the WAPs independently.

PET-Powered Telecommunication System (MAS Embodiment)

In FIG. 8, another embodiment of the telecommunication system is shown and described in the context of a Macro Antenna or MAS Telecommunication System 400 which transmits/receives RF signals to/from a Base Transceiver Station (BTS) 410. This embodiment, however, also illustrates a teaching which is more broadly applicable to a power/data distribution system (PD2S) 500 which may be viewed as comprising the elements shown within the dashed lines 510 surrounding a connecting interface/distribution box 520.

Therein, power and data may be transmitted over large distances, i.e., far greater than a few hundred feet (more typical for the Macro Antenna System shown in FIG. 8). In this embodiment, a power component of the power/data distribution system (PD2S) may be: (i) conveyed over a high gauge, low weight copper cable 530, (ii) maintained at a first power level above a threshold on a first side (identified by arrow S1) of the connecting interface/distribution box 520, and (iii) lowered to a second power level below the threshold on a second side (denoted by arrow S2) of the connecting interface 520. A data component of the power/data distribution system PD2S may be: (i) carried over a conventional, light-weight, fiber optic cable 540 and (ii) passed through the connecting interface/distribution box 520 with, or without, interrupting the fiber optic cable 540 such as by a fiber optic coupler (not shown). With respect to the latter, the fiber optic cable 540 may be passed over, or around, the interface/distribution box 520 without discontinuing, breaking or severing the fiber optic cable 540. Alternatively, the fiber optic cable 540 may be terminated in the distribution box 520 and converted, by a fiber switch (similar to the fiber switch shown in FIG. 7) to convert optic data into data suitable for being carried over a coaxial cable.

It should be appreciated that various technologies may be brought to bear on the power/data distribution system (PD2S). For example, Wave Division Multiplexing (WDM) may be used to carry multiple frequencies, i.e., the frequencies used by various service providers/carriers, along a common fiber optic cable. This technology may also be used to carry the signal across greater distances. Additionally, to provide greater flexibility or adaptability, a splitter (not shown) may be employed to split the fiber optic signal, i.e., the data being conveyed to the distribution box 520, such that it may be conveyed/connected to one of the many Remote Radio Units associated with the service providers making use/leasing space on the same tower/elevated structure 412.

Digital energy or Packet Energy Transfer (PET) technology, is employed on the first or upstream side S1 of the connecting interface/distribution box 520 while analog energy or power, i.e., conventional AC/DC power, is employed on the second or downstream side S2 of the interface/distribution box 520. In the context used herein, digital power is characterized by the delivery of discrete packets of energy conveyed on periodic or regular schedule over a conductive wire cable. In the described embodiment, the digital energy employed is high potential, e.g., at or about three-hundred forty-five volts (DC 345 V), significantly above a threshold established by Underwriters Laboratory (UL) which identifies a far lower threshold as a transition point/voltage for safe handling of a power circuit. That is, UL has established a threshold of sixty volts of direct current (DC 60 V) as the transition voltage wherein it is recommended that skilled/certified/licensed tradesman be employed to perform installation, maintenance and repair of electrical circuits carrying a voltage above this this threshold.

Inasmuch as digital power offers alternative mechanisms for safe handling and does not have an upper potential limit for the packets of digital energy delivered, PET technology provides an elegant solution for this leg of the PDS. Furthermore, since PET technology may be delivered over high gauge, low weight metal or copper cable, conventional Category 5 or 6 cable may be used on the first, or upstream side S1 of the PDS. Category 5 or 6 cable is universally carried by service technician, hence, such cable may be cut, sized and prepared for connection to an interface port in the field. That is, there is no need to special order a length of heavy, low gauge, copper cable to traverse the height of a cell tower 412.

The second, or downstream side S2 of the PDS is characterized by the use of analog power which may be carried by conventional direct or alternating current. However, before being conveyed to the downstream side S2 of the PDS, the digital power must be converted to a form which may be handled by tradesman having a far lower skill level. That is, upstream of, and prior to crossing, the interface/distribution box 520, a power converter 550 receives the periodically-conveyed energy packets and converts the same to an uninterrupted, continuous stream of current (e.g., DC 60 V). A similar Category 5 or 6 coaxial cable 560 may be employed on the second side S2 of the PDS, facilitating commonality of inventory and the attendant cost advantages associated therewith. In the described embodiment, a DC-to-DC converter 550 is shown inasmuch as the remote radio heads are powered by direct current. However, it should be appreciated that alternating current may be employed, hence a DC-to-AC converter may be employed.

Inasmuch as the connecting interface/distribution box 520 is oftentimes in region of high interference or may be subject to lightning strikes, the distribution box 520 is conductive and electrically connected to a grounded structure. Furthermore, inasmuch as components of the PD2S are equally vulnerable, they too may be housed/protected within the distribution box 520. In the described embodiment, at least the power converter 550 and a PET receiver 420R are housed within and protected by the interface/distribution box 520.

Referring once again to FIG. 8, the MAS telecommunication system 400 transmits/receives RF signals to/from a Base Transceiver Station (BTS) 402 which houses the transceiver equipment associated with one or more service providers. The MAS telecommunication system 400 includes: (i) a Base Band Unit (BBU) 404 operated by a service provider such as Verizon, Comcast or AT&T, (ii) one or more telecommunication antennas 408, e.g., sector antennas, mounted atop the tower/elevated structure 412 for receiving/transmitting RF signals from/to a plurality of cellular devices, (iii) remote radio units (RRU) 420 operative to transmit/receive/amplify/repeat RF signals between the BBUs 404 and the telecommunication antennas 408 (iv) a PET system 420 operative to power transmitter 420T including a source controller 424,

The PET power distribution system 420 includes a PET transmitter 420T, a PET receiver 420R, the first side copper cable 530 and the fiber optic cable 540. Similar to the previous embodiments the fiber optic cable 540 may be disposed in combination with the copper or metal cable 540 to produce a hybrid cable. In the described embodiment, at least the PET receiver 420R and DC-to-DC converter 550 are disposed within the interface/distribution box 520. In the described embodiment, the distribution box 520 is mounted to the tower 412 and provides power to each Remote Radio Units (RRU) 420.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. A telecommunication system comprising:
a master unit configured to exchange data with a cellular station;
a telecommunication antenna configured to exchange data wirelessly with a wireless communication device;
a remote unit connecting the master unit to the telecommunications antenna and exchanging data therebetween; and
a packet energy transfer transmitter configured to transmit packets of electrical power along a conductive cable; and
a packet energy transfer receiver configured to receive and convert the packets of electrical power into a continuous source of power for the remote unit.

2. The telecommunication system of claim 1 wherein the remote unit comprises a conductive outer casing, and wherein the packet energy transfer receiver is enclosed within and electrically shielded by the conductive outer casing.

3. The telecommunication system of claim 2 further comprising:
a hybrid cable connecting the master unit and the packet energy transfer receiver to the remote unit, the hybrid cable comprising a optic fiber for exchanging data and a conductive cable for transmitting power to the packet energy transfer receiver.

4. The telecommunication system of claim 1 further comprising an optic fiber cable configured to exchange data between the master unit and a plurality of remote units, and further comprising a wave division multiplexer configured to send multiple signals through the optic fiber cable to each of the remote units.

5. The telecommunication system of claim 1 wherein the packet energy transfer receiver produces a continuous source of analog power having a first potential; and further comprising:
a converter configured to receive the source of analog power and reduce the analog power from the first to a second potential, the second potential being lower than a threshold potential.

6. The telecommunication system of claim 5 wherein the threshold potential is a safety threshold regulated by a governing authority.

7. The telecommunication system of claim 5 wherein the first potential is higher than the second potential by at least an order of magnitude.

8. The telecommunication system of claim 5 wherein the converter includes an interface port comprising a multi-pin connector.

9. The telecommunication system of claim 7 wherein the conductive cable is configured to carry a first current on a first side of an interface port and a second current on a second side of the interface port, the first current being larger than the second current.

10. The telecommunication system of claim 5 wherein the remote unit includes a conductive outer casing, and wherein the converter is enclosed within and electrically shielded by the conductive outer casing.

11. The telecommunication system of claim 5 wherein the converter is a DC-to-DC converter.

12. The telecommunication system of claim 5 wherein the converter is a DC-to-AC inverter.

13. The telecommunication system of claim 5 wherein the second potential less than about sixty volts.

14. The telecommunication system of claim 2 further comprising an interface port integrated with the outer casing, the interface port having a plurality of interface elements, the interface elements comprising one of an optical connection and a conductive pin connection.

15. A power-data distribution system for a DAS telecommunication system comprising:
a power distribution system having a packet energy transfer transmitter and a packet energy transfer receiver,
a remote radio unit: (i) electrically powered by the packet energy transfer receiver, (ii) optically and electrically coupled to a cellular radio, and (iii) electrically coupled to a plurality of telecommunication antennas, the telecommunication antennas wirelessly exchanging data with a plurality of cellular communication devices;
a wireless fidelity access point device having an internal antenna operative to exchange internet data with a WAP-enabled device; and
a fiber media converter: (i) optically and electrically coupled to the packet energy transfer receiver, and (ii) electrically coupled to the WAP-enabled device.

16. The power-data distribution system of claim 15 further comprising a Power over Ethernet cable interposing the fiber media converter and the WAP-enabled device and wherein electrical power and internet data are carried over a wire cable of the Power over Ethernet cable.

17. The power-data distribution system of claim 16 further, comprising:
a hybrid cable interposing the packet energy transfer transmitter and the packet energy transfer receiver and configured to optically and electrically connect the fiber media converter to the cellular radio.

18. The power-data distribution system of claim 16 wherein the remote unit comprises a conductive outer casing, and wherein the packet energy transfer receiver is enclosed within and electrically shielded by the conductive outer casing.

19. The power-data distribution system of claim 16 wherein the packet energy transfer receiver produces a continuous source of analog power having a first potential; and further comprising:
a converter configured to receive the source of analog power and reduce the analog power from the first to a second potential, the second potential being lower than a threshold potential.

20. The power-data distribution system of claim 19 wherein the threshold potential is a safety threshold regulated by a governing authority.
